(19) United States
(12) Patent Application Publication
(10) Pub. No.: US 2026/0051774 A1
(43) Pub. Date: Feb. 19, 2026

(54) MIXED MAGNET ROTOR WITH POLYMER OVERMOLDED END RINGS

(71) Applicant: GM Global Technology Operations LLC, Detroit, MI (US)

(72) Inventors: Alireza Fatemi, Canton, MI (US); Anthony Michael Coppola, Rochester Hills, MI (US); Thomas W. Nehl, Shelby Twp., MI (US); Derek Frei Lahr, Ann Arbor, MI (US)

(21) Appl. No.: 18/808,670

(22) Filed: Aug. 19, 2024

(51) Int. Cl. H02K 1/28; H02K 1/276; H02K 1/32; H02K 15/03; H02K 15/12

(52) U.S. Cl. CPC H02K 1/28; H02K 1/276; H02K 1/32; H02K 15/03; H02K 15/12

(57) ABSTRACT

A motor for a vehicle includes a rotor assembly. The rotor assembly includes a rotor core including a plurality of laminations, the rotor core having a cylindrical body with a rotor bore, the cylindrical body having a first face at a first longitudinal end and a second face at a second longitudinal end, a slot through the body of the rotor core, the slot extending along a longitudinal axis of the rotor core from the first longitudinal end to the second longitudinal end, a magnet disposed in the slot with an end portion of the magnet located at the first face of the first longitudinal end, and a polymer end ring at the first longitudinal end, wherein the polymer end ring covers the end portion of the magnet at the first face and forms a composite cage integrated inside the rotor core.

The subject disclosure relates to electric motors used in vehicles and, in particular, to a rotor assembly of the electric motor having over molded end rings.

An electric motor includes a stator and a rotor that rotates within the stator about an axis. The rotor can be made of a rotor assembly including slots extending axially. The slots include magnets therein. End rings are placed at opposite axial ends of the rotor to contain the magnets. In order to apply the end rings, the ends of the magnets generally need to be filed down or ground down to be flush with the face of the rotor or to reside entirely within the slots. Such methods are time-consuming and difficult to perform. Accordingly, it is desirable to provide a method for forming an end ring on the rotor assembly that encapsulates portions of any magnets that may extend outside of the slot.

### SUMMARY

In one exemplary embodiment, a method of manufacturing a rotor assembly is disclosed. A plurality of laminations are stacked to form a rotor core, the rotor core having a cylindrical body with a rotor bore, the cylindrical body having a first face at a first longitudinal end and a second face at a second longitudinal end. A slot is formed through the rotor core, the slot extending along a longitudinal axis of the rotor core from the first longitudinal end to the second longitudinal end. A magnet is disposed in the slot with an end portion of the magnet located at the first face of the first longitudinal end. A polymer end ring is formed at the first longitudinal end to cover the end portion of the magnet at the first face, wherein the polymer end ring forms a composite cage integrated inside the rotor core.

In addition to one or more of the features described herein, the end portion of the magnet extends outside of the slot at the first face.

In addition to one or more of the features described herein, the method further includes adhering the composite cage to the rotor core at an inner surface of the slot.

In addition to one or more of the features described herein, the polymer end ring is reinforced by a metallic rim.

In addition to one or more of the features described herein, the end portion of the magnet includes an adhering feature, the method further including encapsulating the adhering feature with the polymer end ring to adhere the end portion of the magnet to the polymer end ring.

In another exemplary embodiment, a rotor assembly is disclosed. The rotor assembly includes a rotor core, a slot through a body of the rotor core, a magnet disposed int eh slot and a polymer end ring. The rotor core includes a plurality of laminations and has a cylindrical body with a rotor bore. The cylindrical body has a first face at a first longitudinal end and a second face at a second longitudinal end. The slot extends along a longitudinal axis of the rotor core from the first longitudinal end to the second longitudinal end. The magnet is disposed in the slot with an end portion of the magnet located at the first face of the first longitudinal end. The polymer end ring is at the first longitudinal end, covers the end portion of the magnet at the first face and forms a composite cage integrated inside the rotor core.

In addition to one or more of the features described herein, the end portion of the magnet extends outside of the slot at the first face.

In addition to one or more of the features described herein, the slot further includes a first slot and a second slot and the magnet includes a first magnet disposed in the first slot and a second magnet disposed in the second slot, and wherein the first magnet and the second magnet are at least one of made of a first material and a second material, respectively, a Ferrite magnet and a Neodymium magnet, respectively, and a ground magnet and an unground magnet, respectively.

In addition to one or more of the features described herein, the composite cage further includes a hollow structure that allows passage of a cooling fluid through the rotor core.

In addition to one or more of the features described herein, the composite cage is filled with at least a glass fiber.

In addition to one or more of the features described herein, the composite cage adheres to the rotor core at an inner surface of the slot.

In addition to one or more of the features described herein, the polymer end ring is reinforced by a metallic rim.

In addition to one or more of the features described herein, the end portion of the magnet includes an adhering feature and the polymer end ring encapsulates the adhering feature to adhere the end portion of the magnet to the polymer end ring.

In yet another exemplary embodiment, a vehicle is disclosed. The motor includes a motor including a stator having a stator bore and a rotor assembly disposed within the stator bore and configured to rotate within the stator. The rotor assembly includes a rotor core including a plurality of laminations, the rotor core having a cylindrical body with a rotor bore, the cylindrical body having a first face at a first longitudinal end and a second face at a second longitudinal end, a slot through the body of the rotor core, the slot extending along a longitudinal axis of the rotor core from the first longitudinal end to the second longitudinal end, a magnet disposed in the slot with an end portion of the magnet located at the first face of the first longitudinal end, and a polymer end ring at the first longitudinal end, wherein the polymer end ring covers the end portion of the magnet at the first face and forms a composite cage integrated inside the rotor core.

In addition to one or more of the features described herein, the end portion of the magnet extends outside of the slot at the first face.

In addition to one or more of the features described herein, the slot further includes a first slot and a second slot and the magnet includes a first magnet disposed in the first slot and a second magnet disposed in the second slot, and wherein the first magnet and the second magnet are at least one of made of a first material and a second material, respectively, a Ferrite magnet and a Neodymium magnet, respectively, and a ground magnet and an unground magnet, respectively.

In addition to one or more of the features described herein, the composite cage further includes a hollow structure that allows passage of a cooling fluid through the rotor core.

In addition to one or more of the features described herein, at least one of the composite cage is filled with at least a glass fiber and the composite cage adheres to the rotor stack core at an inner surface of the slot.

In addition to one or more of the features described herein, the polymer end ring is reinforced by a metallic rim.

In addition to one or more of the features described herein, the end portion of the magnet includes an adhering feature and the polymer end ring encapsulates the adhering feature to adhere the end portion of the magnet to the polymer end ring.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a schematic view of a motor in accordance with an exemplary embodiment;

FIG. 2 shows a side view of a rotor of the motor, in an illustrative embodiment;

FIG. 3 shows a top perspective view of the rotor, in an embodiment;

FIG. 4 is a diagram illustrating an injection molding operation for the rotor;

FIG. 5 shows a perspective view of the rotor core after an injection molding operation;

FIG. 6 shows a side cross-sectional view of the rotor core with polymer end rings, in an embodiment;

FIG. 7 shows an enlarged view of the rotor core at the rectangle of FIG. 6;

FIG. 8 shows a side cross-sectional view of the rotor core with polymer end rings, in another embodiment;

FIG. 9 shows a side cross-sectional view of a slot at a first end of the rotor core, in an embodiment; and

FIG. 10 shows a vehicle that includes the motor of FIG. 1.

### DETAILED DESCRIPTION

The following description is merely exemplary in nature and is not intended to limit the present disclosure, its application or uses. It should be understood that throughout the drawings, corresponding reference numerals indicate like or corresponding parts and features.

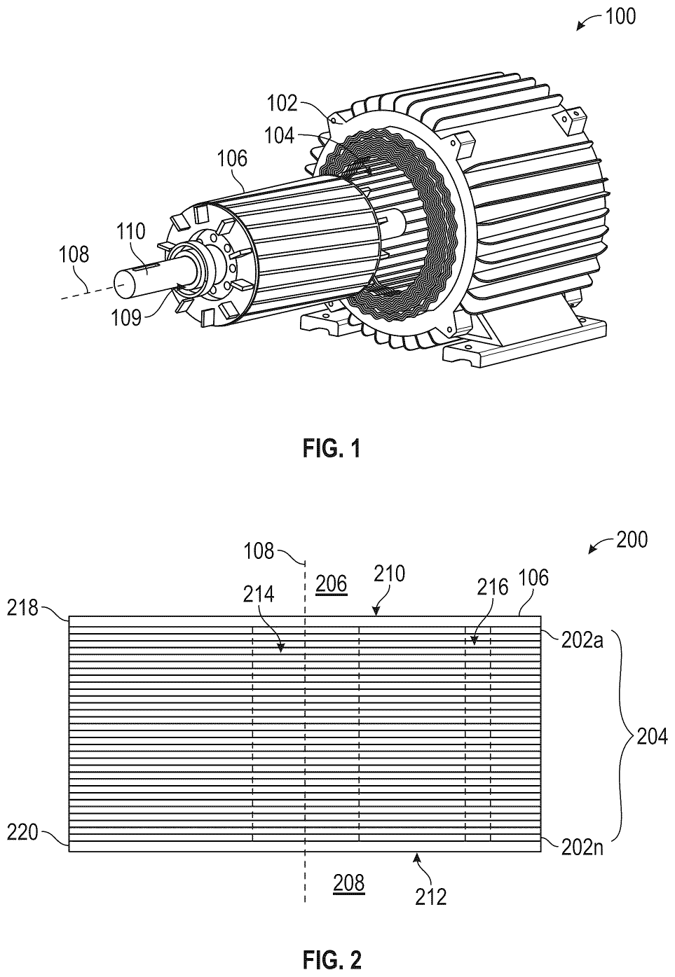

In accordance with an exemplary embodiment, FIG. 1 shows a schematic view of a motor 100. The motor 100 can be a motor used in a vehicle. The motor 100 includes a stator 102 having a stator bore 104 along a longitudinal axis 108. A rotor 106 is disposed withing the stator bore 104. The rotor 106 rotates within the stator 102 about the longitudinal axis 108. The rotor 106 includes a rotor bore 109, and a rotor shaft 110 is disposed within the rotor bore. The rotor shaft 110 is mechanically connected to the rotor 106 and rotates with the rotor to transfer power and/or torque to various components of the vehicle, such as an engine, a transmission, wheels, etc.

FIG. 2 shows a side view 200 of the rotor 106 in an illustrative embodiment. The rotor 106 includes a plurality of laminations 202a-202n stacked on top of each other along the longitudinal axis 108 to form a rotor core 204. The rotor core 204 has a cylindrical body that extends from a first longitudinal end 206 to a second longitudinal end 208. The rotor core 204 has a first face 210 at the first longitudinal end 206 and a second face 212 at the second longitudinal end 208. A rotor bore 214 of the rotor core 204 (within which the rotor shaft 110 is placed) is indicated by dotted lines. Multiples slots are formed within the body of the rotor core 204 for storing magnets. For purposes of illustration, a slot 216 within the rotor core 204 is indicated by dotted lines. The slot 216 extends from the first face 210 to the second face 212 and passes through each of the plurality of laminations 202a-202n.

A first end ring 218 of the rotor 106 is formed at the first face 210 and a second end ring 220 is formed at the second face 212. The first end ring 218 and/or the second end ring 220 can be a polymer end ring formed during an injection stage as part of manufacture of the rotor.

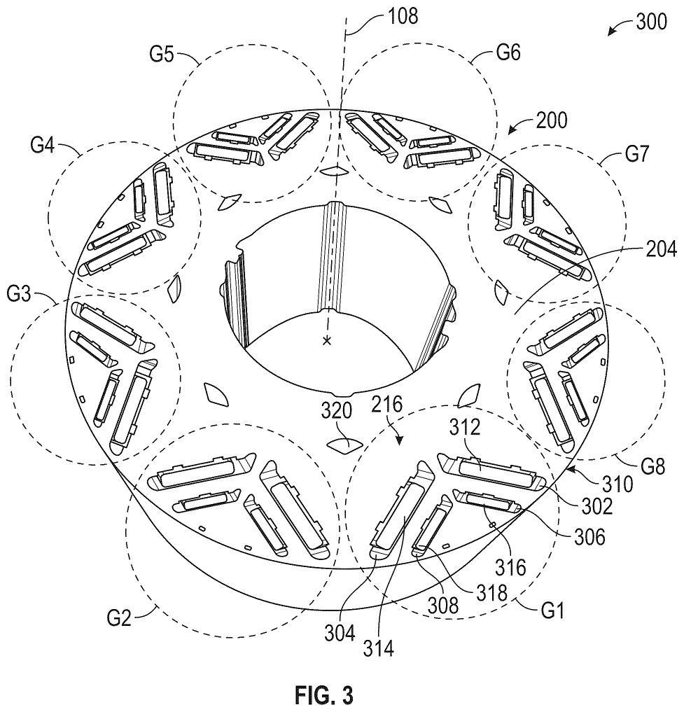

FIG. 3 shows a top perspective view 300 of the rotor 106, in an embodiment. The perspective view 300 displays one or more slots in the rotor core 204. The slots 216 are generally arranged in groups. Groups G1-G8 are shown for illustrative purposes. The slots 216 can have a selected arrangement within each group. Each slot has a magnet that is disposed therein. The magnets extend along the longitudinal axis 108 of the rotor. A magnet within a slot can be a single magnet or a plurality of magnets stacked within the slot along the longitudinal axis.

The slots 216 in group G1 are discussed for the purpose of illustration. A first major slot 302 and a second major slot 304 form a first chevron with an open end of the first chevron facing the outer rim 310 of the rotor core 204. A first minor slot 306 and a second minor slot 308 form a second chevron with an open end of the second chevron facing the outer rim 310. A first major magnet 312 is disposed within the first major slot 302 and a second major magnet 314 is disposed within the second major slot 304. A first minor magnet 316 is disposed within the first minor slot 306 and a second minor magnet 318 is disposed within the second minor slot 308. Cooling channels, such as cooling channel 320, are disposed at circumferential locations between the groups.

The slots can have different magnet types stored therein. For example, a first slot can house a first magnet made of a first material and a second slot can house a second magnet made of a second material. In an embodiment, the first material can be Ferrite and the second material can be Neodymium. The first magnet can be a ground magnet and the second magnet can be an unground magnet. For example, the Ferrite magnet can be grounded and the Neodymium magnet can be ungrounded.

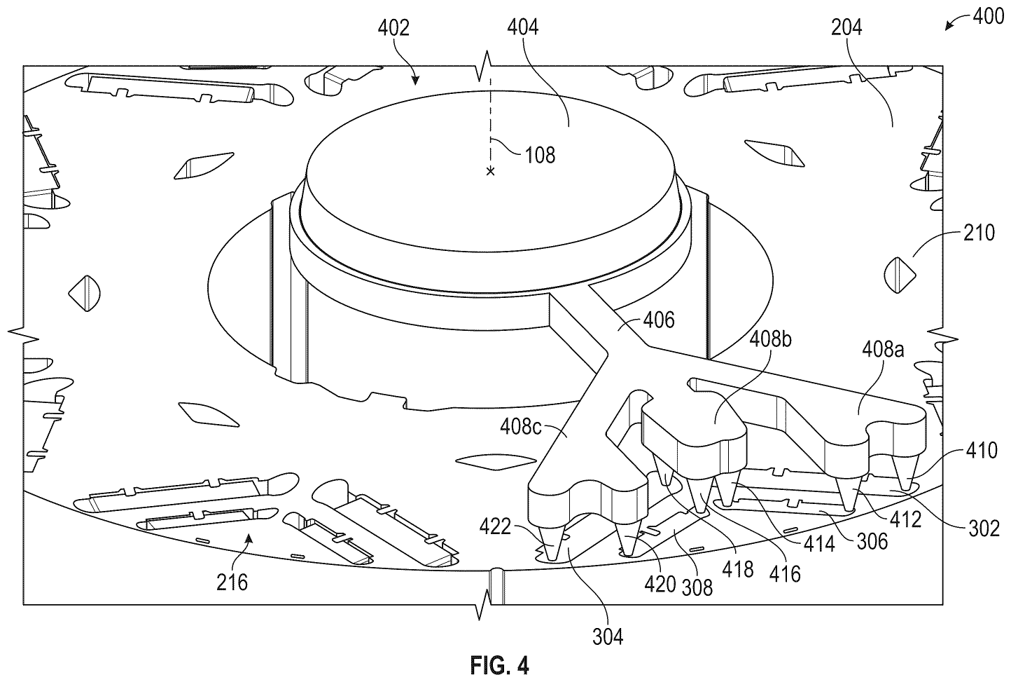

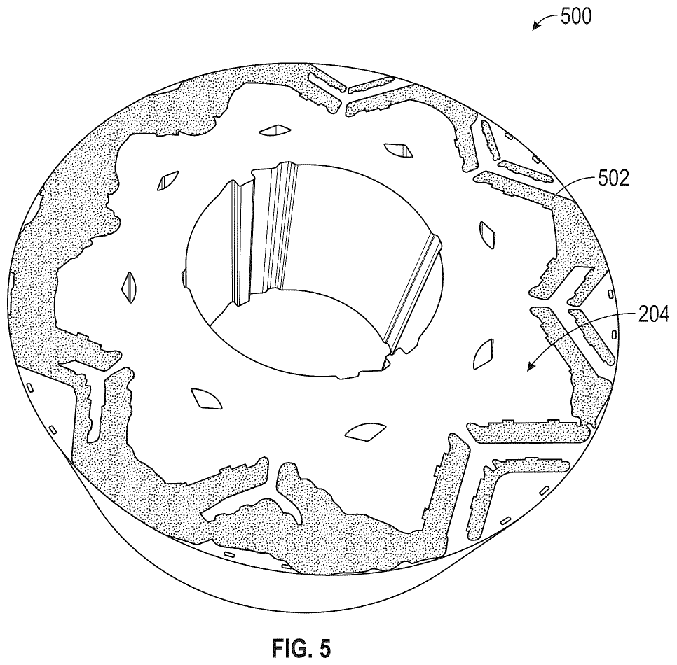

FIG. 4 is a diagram 400 illustrating an injection molding operation for the rotor. An injection molding tool 402 is shown including a central cylinder 404 located along the central axis 108 of the rotor core 204. A polymer is injected from the central cylinder 404 into the slots 216 via various branches, sub-branches, and nozzles. A branch 406 extends radially outward from the central cylinder 404 above the first face 210 of the rotor core 204. Although only one branch is shown, a plurality of branches can extend from the central cylinder 404. The branch 406 has one or more sub-branches 408a-408c. Each of the one or more sub-branches 408a-408c has one or more nozzles extending to the first face and into a respective one of the slots 216. A first sub-branch 408a includes a first nozzle 410 for injecting into first major slot 302 and a second nozzle 412 for injection into the first minor slot 306. The second sub-branch 408b includes nozzles (nozzles 414, 416, 418 are visible) for each of the slots. The third sub-branch 408c includes nozzle 420 for injecting the polymer into the second major slot 304 and nozzle 422 for injecting the polymer into the second minor slot 308.

FIG. 5 shows a perspective view 500 of the rotor core 204 after an injection molding operation. The polymer 502 is shown coating the various slots 216 of the rotor core 204 as well as encapsulating the magnets.

It is to be understood that, while FIGS. 3-5 show the polymer within slots of the rotor core but without any polymer end rings, the methods disclosed herein relates to injecting polymer to form in a single structure including the polymer end rings as well as a cage structure within slots of the rotor core.

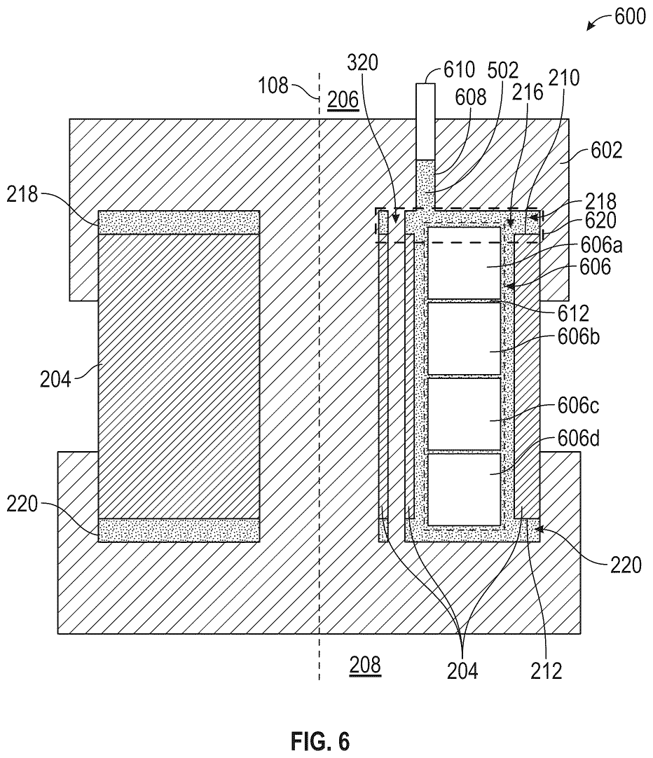

FIG. 6 is a side cross-sectional view 600 showing a tooling of the rotor core 204 to form polymer end rings, in an embodiment. A tooling device 602 envelops portions of the rotor core 204. The rotor core 204 includes a slot 216 and a magnet stack 606 within the slot. The magnet stack 606 includes a plurality of magnets 606a-606d stacked within the slot 216 along the longitudinal axis 108 of the rotor core 204. An end magnet 606a or top magnet of the magnet stack 606 has a portion that extends outside of the slot 604 and above the first face 210 of the rotor core 204. Similarly, the end magnet 606d can have a portion that extends outside of the slot 604 and below the second face 212.

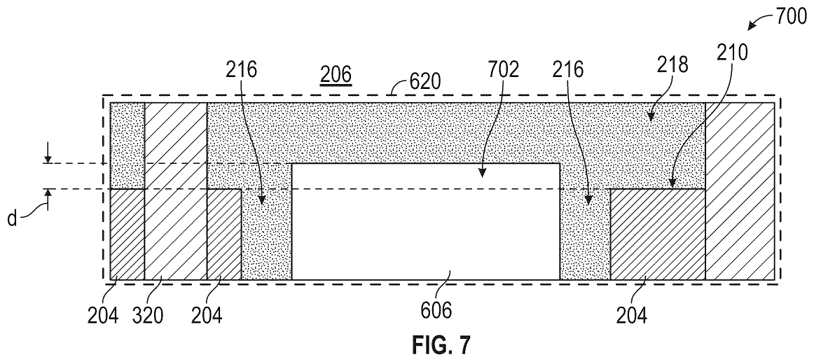

The tooling device 602 surrounds the ends of the rotor core 204, the rotor bore and the cooling channel 320. The tooling device 602 includes a conduit 608 for introducing the polymer to the rotor core 204. A nozzle 610 extends through the conduit 608 of the tooling device 602. The nozzle 610 introduces a polymer 502 into the conduit 608. The polymer 502 spreads across the first face 210 of the rotor core 204 to form a first end ring 218. The polymer 502 also flows into and through the slot 604 and between the magnets 606a-606d to bind the magnets in place within the slot. The polymer 502 flows between the magnets and forms layers (e.g., layer 612) between adjacent magnets (e.g., end magnet 606a and magnet 606b). The polymer 502 flows out of the slot 604 at the second longitudinal end 208 to spread across the second face 212 of the rotor core 204o form the second end ring 220. FIG. 7 shows an enlargement of a region indicated by rectangle 620.

The polymer 502 can take the shape of a composite cage by flowing into the slots of the rotor core. The composite cage can include a hollow structure that allows passage of a cooling fluid through the rotor core. In an embodiment, the polymer is filled with at least a glass fiber. The composite cage adheres to the rotor core at an inner surface of the slot 604.

FIG. 7 shows an enlarged view 700 of the rotor core 204 at the rectangle 620 of FIG. 6. The enlarged view 700 shows the slot 216 at the first face 210. End magnet 606a is disposed in the slot 216. An end portion 702 of the end magnet 606a extends out of slot 216 and above the first face 210 by a distance d. The first end ring 218 forms a polymer coating that covers the end portion 702 of the end magnet 606a.

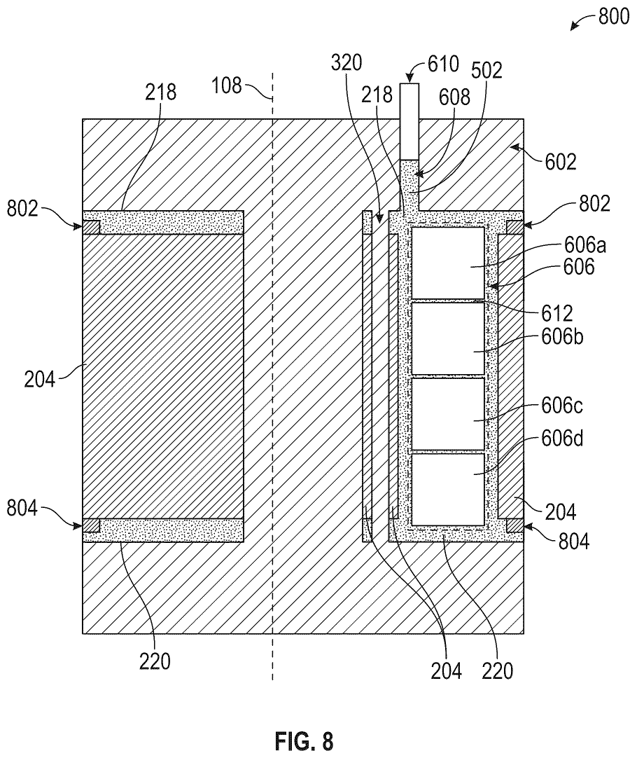

FIG. 8 shows a side cross-sectional view 800 of the rotor core 204 with polymer end rings, in another embodiment. The side cross-sectional view 800 includes a first metal ring 802 that provides reinforcement to the polymer of the first end ring 218 and a second metal ring 804 that provides reinforcement to the polymer of the second end ring 220. The metal ring can be between the polymer 502 and the rotor core. Alternatively, the polymer 502 can be between the metal ring and the rotor core. The metal can be aluminum, in various embodiments. Thus, the first end ring 218 is a bi-material (i.e., including the polymer of the first end ring 218 and the metal of the first metal ring 802. Similarly, the second end ring 220 is a bi-material (i.e., including the polymer of the second end ring 220 and the metal of the second metal ring 804).

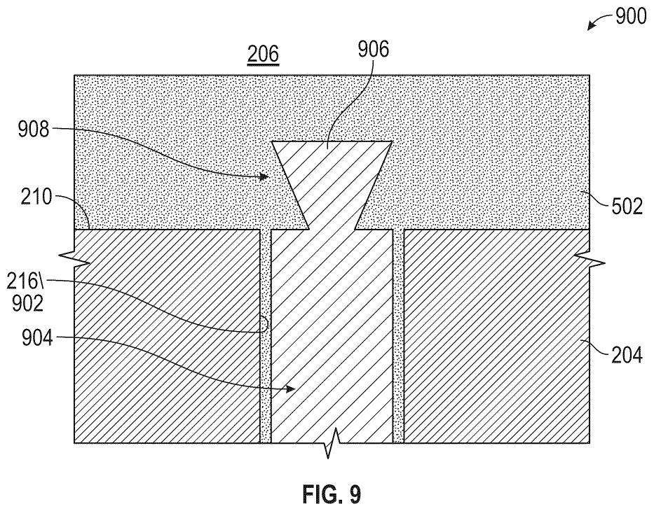

FIG. 9 shows a side cross-sectional view 900 of a slot 902 at a first end of the rotor core, in an embodiment. An end magnet 904 is disposed in the slot and includes an adhering feature 906 that promotes adhesion between the polymer 502 and the end magnet 904. In one embodiment, the adhering feature 906 can include a notch 908 or a rough surface at the end of the magnet. The polymer 502 completely encapsulates the portion of the magnet that extends outside of the slot, including the notch 908. In another embodiment, the adhering feature 906 can be an adhesive substance. The end of the magnet can be degreased and then treated with silane, conversion coating, resin, or other adhesion promoting chemical. The resin can be a polyurethane or an acrylic that inherently sticks to metals. The polymer can completely encapsulate the portion of the magnet that sticks out of the electrical steel core.

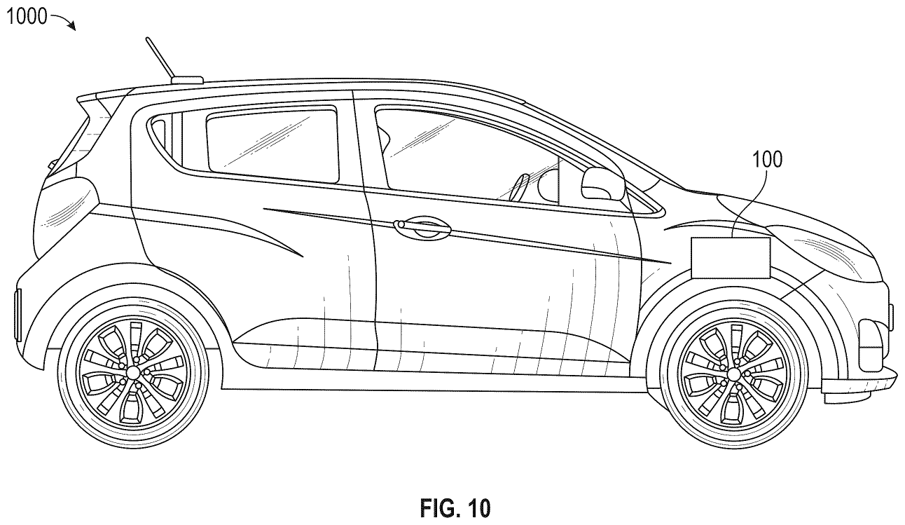

FIG. 10 shows a vehicle 1000 that includes the motor of FIG. 1.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on”another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of manufacturing a rotor assembly, comprising:
stacking a plurality of laminations to form a rotor core, the rotor core having a cylindrical body with a rotor bore, the cylindrical body having a first face at a first longitudinal end and a second face at a second longitudinal end;
forming a slot through the rotor core, the slot extending along a longitudinal axis of the rotor core from the first longitudinal end to the second longitudinal end;
disposing a magnet in the slot with an end portion of the magnet located at the first face of the first longitudinal end; and
forming a polymer end ring at the first longitudinal end to cover the end portion of the magnet at the first face, wherein the polymer end ring forms a composite cage integrated inside the rotor core.

2. The method of claim 1, wherein the end portion of the magnet extends outside of the slot at the first face.

3. The method of claim 1, further comprising adhering the composite cage to the rotor core at an inner surface of the slot.

4. The method of claim 1, wherein the polymer end ring is reinforced by a metallic rim.

5. The method of claim 1, wherein the end portion of the magnet includes an adhering feature, further comprising encapsulating the adhering feature with the polymer end ring to adhere the end portion of the magnet to the polymer end ring.

6. A rotor assembly, comprising:
a rotor core including a plurality of laminations, the rotor core having a cylindrical body with a rotor bore, the cylindrical body having a first face at a first longitudinal end and a second face at a second longitudinal end;
a slot through the cylindrical body of the rotor core, the slot extending along a longitudinal axis of the rotor core from the first longitudinal end to the second longitudinal end;
a magnet disposed in the slot with an end portion of the magnet located at the first face of the first longitudinal end; and
a polymer end ring at the first longitudinal end, wherein the polymer end ring covers the end portion of the magnet at the first face and extends inside the slot to form to form a composite cage integrated inside the rotor core.

7. The rotor assembly of claim 6, wherein the end portion of the magnet extends outside of the slot at the first face.

8. The rotor assembly of claim 6, wherein the slot further includes a first slot and a second slot and the magnet includes a first magnet disposed in the first slot and a second magnet disposed in the second slot, and wherein the first magnet and the second magnet are at least one of: (i) made of a first material and a second material, respectively; (ii) a Ferrite magnet and a Neodymium magnet, respectively; and (iii) a ground magnet and an unground magnet, respectively.

9. The rotor assembly of claim 6, wherein the composite cage further comprises a hollow structure that allows passage of a cooling fluid through the rotor core.

10. The rotor assembly of claim 6, wherein the composite cage is filled with at least a glass fiber.

11. The rotor assembly of claim 6, wherein the composite cage adheres to the rotor core at an inner surface of the slot.

12. The rotor assembly of claim 6, wherein the polymer end ring is reinforced by a metallic rim.

13. The rotor assembly of claim 6, wherein the end portion of the magnet includes an adhering feature and the polymer end ring encapsulates the adhering feature to adhere the end portion of the magnet to the polymer end ring.

14. A vehicle, comprising:
a motor including a stator having a stator bore;
a rotor assembly disposed within the stator bore and configured to rotate within the stator, the rotor assembly including:
a rotor core including a plurality of laminations, the rotor core having a cylindrical body with a rotor bore, the cylindrical body having a first face at a first longitudinal end and a second face at a second longitudinal end;
a slot through the cylindrical body of the rotor core, the slot extending along a longitudinal axis of the rotor core from the first longitudinal end to the second longitudinal end;
a magnet disposed in the slot with an end portion of the magnet located at the first face of the first longitudinal end; and
a polymer end ring at the first longitudinal end, wherein the polymer end ring covers the end portion of the magnet at the first face and extends inside the slot to form a composite cage integrated inside the rotor core.

15. The vehicle of claim 14, wherein the end portion of the magnet extends outside of the slot at the first face.

16. The vehicle of claim 14, wherein the slot further includes a first slot and a second slot and the magnet includes a first magnet disposed in the first slot and a second magnet disposed in the second slot, and wherein the first magnet and the second magnet are at least one of: (i) made of a first material and a second material, respectively; (ii) a Ferrite magnet and a Neodymium magnet, respectively; and (iii) a ground magnet and an unground magnet, respectively.

17. The vehicle of claim 14, wherein the composite cage further comprises a hollow structure that allows passage of a cooling fluid through the rotor core.

18. The vehicle of claim 14, wherein at least one of: (i) the composite cage is filled with at least a glass fiber; and (ii) the composite cage adheres to the rotor core at an inner surface of the slot.

19. The vehicle of claim 14, wherein the polymer end ring is reinforced by a metallic rim.

20. The vehicle of claim 14, wherein the end portion of the magnet includes an adhering feature and the polymer end ring encapsulates the adhering feature to adhere the end portion of the magnet to the polymer end ring.
